(19) United States
(12) Patent Application Publication
(10) Pub. No.: US 2013/0340215 A1
(43) Pub. Date: Dec. 26, 2013

(54) MONEY CLIP AND METHOD OF OPERATING SAME

(71) Applicant: JB Friction & Fab Corporation, Grafton, WI (US)

(72) Inventor: Bryan McGourthy, Mequon, WI (US)

(21) Appl. No.: 13/925,149

(22) Filed: Jun. 24, 2013

Related U.S. Application Data
(60) Provisional application No. 61/663,705, filed on Jun. 25, 2012.

(51) Int. Cl. B42F 1/02

(52) U.S. Cl. CPC B42F 1/02
USPC 24/505

(57) ABSTRACT

A money clip has a spring, and a pair of arms joined by the spring, wherein at least one of the arms includes at least one recess configured to hold coin currency. The money clip further includes a pair of levers, wherein at least one of the levers is configured to rotate from a retracted position to a deployed position, and wherein the levers support coin currency when in retracted position and are used to open the money clip when in deployed position.

### BACKGROUND

The present invention relates to clips for holding money, and more particularly to a rotational money clip able to hold a bundle of paper and/or coin currency.

Devices for holding currency have been employed in many different variations. One common example of such a device is a money clip. The majority of the existing money clips are designed to hold paper currency, credit cards, driver licenses, etc. However, currency generally exists in the form of paper or coin. With the increased circulation of coin currency (e.g., one dollar coins in the United States), a money clip that, for example, is designed to securely hold coin currency as well as paper currency is highly desirable. Also, money clips having reduced size, improved ease of use, and/or stronger currency retention force are always welcome additions to the art.

### SUMMARY

In one embodiment, the invention provides a money clip having a spring, and a pair of arms joined by the spring, wherein at least one of the arms includes at least one recess configured to hold coin currency. The money clip can further include a pair of levers, wherein at least one of the levers is configured to rotate from a retracted position to a deployed position, and wherein the levers support coin currency when in retracted position and are used to open the money clip when in deployed position.

In one embodiment, the invention provides a method of retaining money in a money clip. The method includes positioning money between legs of a spring, and joining a pair of arms to the spring. Each arm includes at least one recess configured to hold coin currency. The method further includes coupling a pair of levers to the respective one of the pair of arms, rotating each lever from a retracted position to a deployed position, supporting the coin currency when the levers are in the retracted position, and opening the money clip by pinching the legs of the spring together when the levers are in the deployed position.

### BRIEF DESCRIPTION OF THE DRAWINGS

FIG. 1 is a perspective view of a money clip according to an embodiment of the present invention, shown with the levers in retracted positions.

FIG. 2 is a side view of the money clip of FIG. 1, where the levers are in retracted positions.

FIG. 3 is a side view of the money clip of FIG. 1, where the levers are in deployed positions.

FIGS. 4 and 5 each illustrate a front view of the money clip of FIG. 1, where the levers are in deployed positions.

FIG. 6 is a side view of the spring of the money clip of FIG. 1.

FIG. 7 is a front view of the pin of the money clip of FIG. 1.

FIG. 8 illustrates operation of the money clip of FIG. 1.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising” or “having” and variations thereof herein is meant to encompass the items listed thereafter and equivalents thereof as well as additional items. The terms “mounted,” “connected” and “coupled” are used broadly and encompass both direct and indirect mounting, connecting and coupling. Further, “connected” and “coupled” are not restricted to physical or mechanical connections or couplings, and can include electrical connections or couplings, whether direct or indirect.

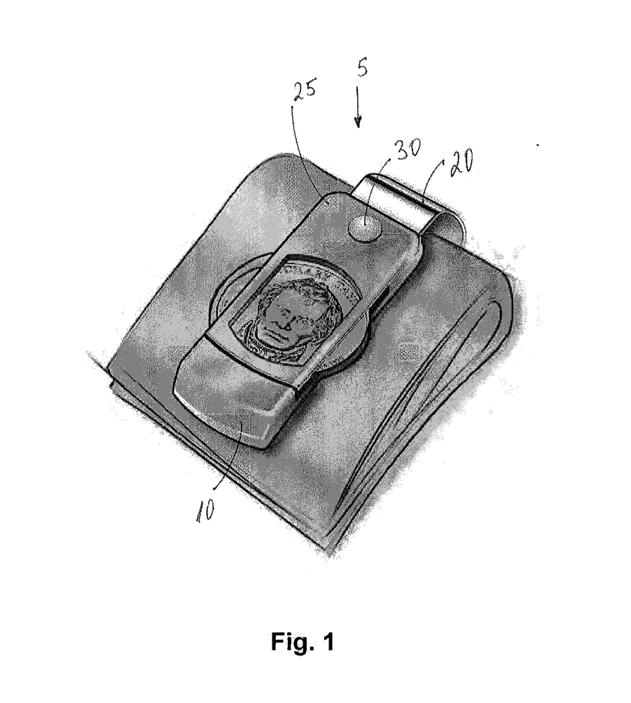

FIGS. 1-3 show a money clip 5 according to an embodiment of the present invention. The illustrated money clip 5 includes two arms 10 joined together by a spring 20, and two rotatable levers 25 pivotally connected to the arms 10 via pins 30. The spring 20 provides force to the arms 10 to hold paper currency, credit cards, driver licenses, etc., in a secure manner. Further, as explained in more detail below, the illustrated arms 10 are each designed to hold one or more coins placed within the body of the respective arm 10. In some embodiments, the arms 10 and the spring 20 are integrally constructed from one piece of material, or the spring 20 and one of the arms 10 are integrally constructed from one piece of material. In other embodiments, the elements of the money clip 5 can be constructed separately and mechanically connected to assemble the clip 5.

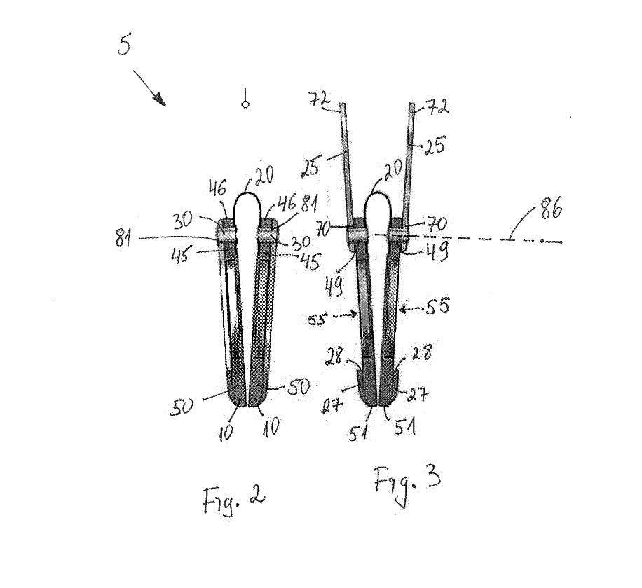

In the illustrated embodiment, each arm 10 has an elongated rectangular form and is constructed from metal (e.g., steel, titanium, aluminum). In other embodiments, the arms 10 can have a different form or shape (e.g., square, oval, etc.) and/or can be constructed from different materials (e.g., durable plastic, wood, ceramic or other refractory material, fiberglass or other composite material, etc.). The arms 10 define a first end 45 (see FIGS. 2-4) adjacent the pins 30 and a second end 50 opposite the pins 30. The first end 45 defines a first edge 46 and the second end 50 defines a second edge 51. The first end 45 of each arm 10 includes an aperture 49 through which a respective pin 30 is inserted to attach the levers 25 to the arms 10. In addition, the second end 50 of each arm 10 in the illustrated embodiment includes an extended portion 27 defining an edge 28. Further, each arm 10 includes a recess 55 located in the exterior surface of the arms 10 (i.e., the surface of each arm 10 facing generally away from paper currency secured within the money clip 5). The recesses 55 are each shaped and dimensioned to retain one or more coins inserted into the recesses 55. In some embodiments, the inner surface of either or both arms 10 (i.e., the surface of each arm 10 that generally faces paper currency secured within the money clip 5) is flat and includes an image (e.g., a company logo) engraved, stamped, embossed, printed, or otherwise provided on the arm 10. In these and other embodiments, the outer surface of either or both arms 10 can include such an image.

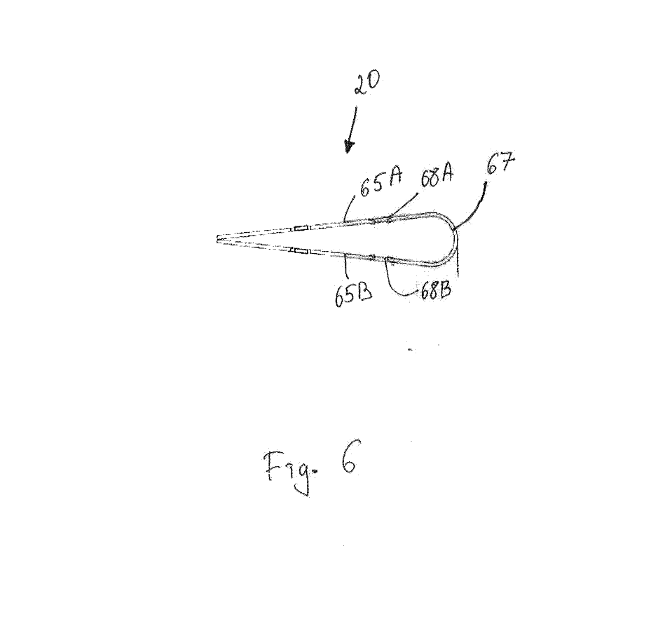

As shown in FIGS. 4 and 5, in some embodiments the recesses 55 of the arms 10 are positioned approximately in the center of the arms 10 (i.e., they are at approximately equal distance from both ends 45/50 of the arms 10), although other locations of the recesses 55 along the arms 10 are possible. In some embodiments, each recess 55 defines a top curved shoulder 56, a bottom curved shoulder 57, and two open ends 58. The curved shoulders 56 and 57 allow the base arms 10 to securely hold a coin inserted into the recesses 55, whereas the open ends 58 permit easy access and removal of the coins by a user. In other embodiments, either or both recesses 55 can instead have other shapes still suitable for retaining one or more coins therein. Also in other embodiments, either or both recesses 55 need not necessarily have one or two open ends 58. In the illustrated embodiment, the diameter of a coin inserted in the recess 55 matches the perimeter of the recess 55 to provide a clearance or snug fit within the recess 55. However, it is to be appreciated that the recesses 55 can have different sizes as desired. The recess 55 can hold coins with diameters that are smaller than the perimeter of the recess 55 by using one or more appropriate springs as described below.

In some embodiments, the arms 10 further include one or more springs 60 (see FIGS. 4 and 5) that are mechanically attached to or adjacent the exterior surface of the arms 10. In some embodiments, at least one such spring 60 is attached near either or both shoulders 56 or 57 of the recesses 55. The springs 60 are configured to extend from the shoulders 56 or 57 into a portion of the recesses 55 to secure one or more coins positioned within the recesses 55 while the money clip 5 is in an open or a deployed state (e.g. FIG. 5). The springs 60 can be attached to the arms 10 in any suitable manner, such as by welding, soldering, brazing, molding, press-fitting, fastening (e.g., with screws, rivets, pins or other fasteners), adhesive or cohesive bonding material, and the like. In some embodiments for example, springs 60 are molded into an insert of, for example, plastic, which is itself attached to an arm 10 of the money clip 5 in any of the manners just described. Such an insert can be provided on either or both arms 10 of the money clip 5 as desired.

In some embodiments, other spring types are used to retain one or more coins in the recesses 55, including without limitation an elastomeric or otherwise deformable element (e.g., a liner, protrusion, or other element made of, for example, urethane, neoprene, plastic, or other polymer material, felt, and the like) in or adjacent the recess 55. As used herein and in the appended claims, the term “spring” is intended to encompass all such elements. Such elements can be positioned to provide a degree of resistance to removal of a coin received within the recess 55, which resistance can be overcome by sufficient pulling, pushing, prying, or other force exerted upon the coin in the recess 55. In other embodiments, the money clip 5 can be constructed without one or more springs 60.

In the embodiment illustrated in FIGS. 1-3, each arm 10 of the money clip 5 holds one coin. In other embodiments, the thickness of the arms 10 and, consequently, of the recesses 55 can be different (e.g., greater than the arms 10 shown in FIG. 1-5). Therefore, the recesses 55 can each hold more than one coin. For example, each recess 55 can hold two coins. In such embodiments, any number of springs 60 can be provided in or adjacent each recess 55 to retain the coins in the recesses 55 as described below, such as by retaining two or more coins in a recess 55 via the same spring 60, by retaining two or more coins in a recess 55 with separate (dedicated) springs 60, etc. Alternatively, the two arms 10 can each have different height, width, or length. For example, the first arm 10 can be thicker than the second arm 10. As a result, the recess 55 of the first arm 10 can hold different number of coins as compared to the recess 55 of the second arm 10 (e.g., 2:1, 1:0, 2:0, etc.).

In those embodiments in which multiple coins are retained on each arm 10 of the money clip, such coins can be retained in a stacked relationship upon one another into a single recess 55. Alternatively, each arm 10 of the money clip can also or instead have multiple recesses 55 (e.g., two or three recesses along the length of the arm 10) each capable of receiving and retaining one or more coins as described herein.

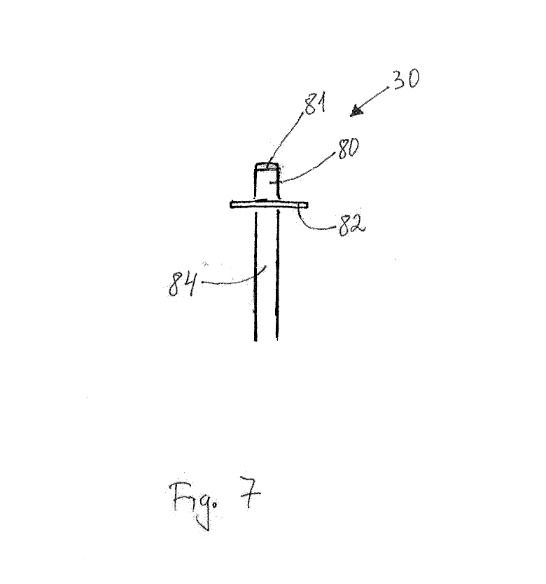

With continued reference to the illustrated embodiment, the spring 20 joins the arms 10 and provides force to the arms 10 to securely hold paper currency in the money clip 5 (as shown in FIG. 1). In the illustrated embodiment (see, in particular, FIG. 6), the spring 20 is constructed from one piece of material (e.g., spring steel, resiliently deformable plastic, or other suitably resiliently deformable material). The illustrated spring 20 includes a body having two legs 65A and 65B and a curved end 67. When the spring 20 is attached to the arms 10 and the money clip 5 is in a retracted state, the curved end 67 of the spring 20 extends beyond the first end 45 of each arm 10, although this is not necessarily the case in other embodiments. In some embodiments, the legs 65A/65B are mechanically connected to the inner surface of the arms 10 (e.g., such as by welding, soldering, brazing, molding, press-fitting, fastening with screws, rivets, pins or other fasteners, adhesive or cohesive bonding material, and the like). As mentioned above, the spring 20 and the arms 10 can also be constructed as one integral structure.

In some embodiments, the legs 65A, 65B of the spring 20 further define apertures 68A and 68B through which pins 30 (described in greater detail below) can be received to secure the arms 10 to the respective legs 65A, 65B of the spring 20.

The rotatable levers 25 of the illustrated money clip 5 have an elongated rectangular form and are constructed from metal (e.g., steel). However, in other embodiments, either or both levers 25 can have any other shape desired, including without limitation other polygonal shapes, round or oval shapes, irregular shapes, and the like, and can be constructed of other materials (e.g., titanium, aluminum, or other metals, durable plastic, wood, ceramic or other refractory material, fiberglass or other composite material, etc.). As shown in FIGS. 2-5, the levers 25 can rotate from respective deployed positions where the levers 25 can be pressed toward one another to open the clip 5 (by separating the arms 10) to retracted positions in which such pressure does not cause separation of the arms 10. In some embodiments, when the levers 25 are in the retracted positions, they are aligned with the arms 10 and/or cover at least a portion of one or more coins in the recesses 55.

In the illustrated embodiment, the length of the levers 25 is smaller than the length of the arms 10, and the levers 25 have the same width as the arms 10. However, in other embodiments, the length of the levers 15 can instead be the same or longer than the length of the arms 10, and the width of the levers 25 can be larger or smaller than the width of the arms.

The illustrated levers 25 include a first end 70 adjacent to the pins 30, a second end 72 distant from the pins 30, and an opening 74 positioned between the first and second ends 70, 72. In other embodiments, either or both levers 25 can be constructed without the opening 74. The first end 70 of each lever 25 defines a first edge 77, and the second end 72 defines a second edge 79 opposite the first edge 77. With continued reference to the illustrated embodiment, when the levers 25 of the money clip 5 are in their retracted positions, the first edges 77 of the levers 25 align with the first edges 46 of the arms 10, and the second edges 79 of the levers 25 interact with the extended portions 27 of the arms 10. Specifically, the edges 79 align with the edges 28 of the extended portions 27 so the levers 25 “cover” the recesses 55 and the coins inserted in the recesses 55. In other embodiments, other lever shapes and sizes having edges or other peripheries (that may or may not align with features on the arms 10) are possible while still performing the function of providing deployed and retracted positions as described herein and/or coin covering and coin exposing positions as also described herein.

Each of the levers 25 in the illustrated embodiment further include an aperture 81 through which the pins 30 rotatably attach the levers 25 to the arms 10 and/or spring legs 65A, 65B. In some embodiments, the apertures 81 are positioned proximate the first end 70 of each lever 25 to enable each lever 25 to swing about an end of the lever 25. In other embodiments, the apertures 81 can be positioned elsewhere along the levers 25 to enable other types of lever movement, such as an aperture 81 located at the middle of each lever 25 to enable the lever 25 to swing about the center of each lever 25 (i.e., to and from a position covering one or more recesses 55 in the respective arms 10 as described above).

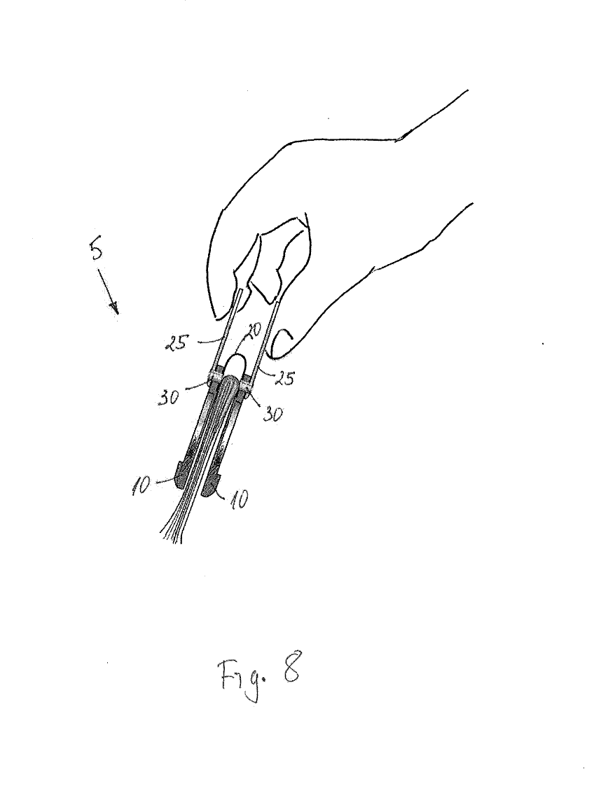

With continued reference to the illustrated embodiment, the aperture 81 can be aligned with the apertures 49 to accept the pins 30, which attach the levers 25 to the arms 10 and further provide for rotational movement of the levers 25 in relation to the arms 10. One example of a pin 30 used in the money clip 5 of the present invention is show in FIG. 7. In the illustrated embodiment, the pin 30 includes a head 80 with a cap portion 81, a shoulder 82, and a body 84. In some embodiments, the body 84 of each pin 30 is inserted through the aperture 49 and the aperture 81. The end portion of the body 84 interacts with the legs 65A, 65B of the spring 20 when the money clip 5 is assembled, whereas the shoulders 82 of the pins 30 are positioned on the outer (exterior) surface of the arms 10, and the heads 80 of the pins extend through the body of the levers 25, and the caps 81 extend slightly over the top surface of the levers 25 in some embodiments.

The attachment of the levers 25 via pins 30 allows for rotation of the levers 25 in relation to the arms 10. Specifically, either or both levers 25 can pivot about an axis 86 (see FIG. 6) extending through the arms 10 and the pins 30. By virtue of this rotation, the levers 25 can move from retracted positions to deployed positions as described above. In the illustrated embodiment, the levers 25 can rotate a full 360 degrees around the axis 86 to retain each lever 25 in its respective plane through rotation, and to rotate it to and from its retracted position. When the levers 25 are retracted to the arms 10, the levers 25 support coins located in the recesses 55. In that configuration, and in those embodiments of the present invention employing openings 74 in the levers 25 as described above, a user can see at least a portion of the coins placed in the recesses 55 through the openings 74 of the levers 25.

In some embodiments, the pin and aperture rotational connection between the levers 25 and the arms 10 and spring legs 65A, 65B can be an over-center connection. In other words, a rotational over-center mechanism (not shown, but well-understood to those skilled in the art) provides resistance to rotation or a rotational bias in one or more rotational positions (e.g., under spring-loaded force) of each lever 25. In such embodiments, the levers 25 can be biased toward their retracted positions over the arms 10 and/or toward their deployed positions as described above, thereby helping to insure that coins within the recesses 55 remain covered by the levers 25 to avoid falling out of the money clip 5, and helping the user place the levers 25 in their properly deployed position for actuation. In these embodiments, after a user employs sufficient rotational force to rotate the levers 25 from their over-center positions, the levers 25 can pivot easily to complete full rotation about the axis 86. Any over-center rotational device or mechanism can be utilized for this purpose, and falls within the spirit and scope of the present invention.

In some embodiments, both levers 25 rotate about their respective axes 86. In other embodiments, one of the levers 25 does not rotate. In such a configuration, the non-rotatable arm 10 can be constructed without the opening 74, and can include a logo on an outer surface. Also, in some embodiments, the outer surface of either or both arms 10, and/or the outer surfaces of either or both levers 25, can be covered with a removable plastic cap (not shown) that includes a text or graphics as desired. Further, the opening 74 can have different forms and shapes, and can be used as a bottle opener when the levers 25 are in their deployed positions.

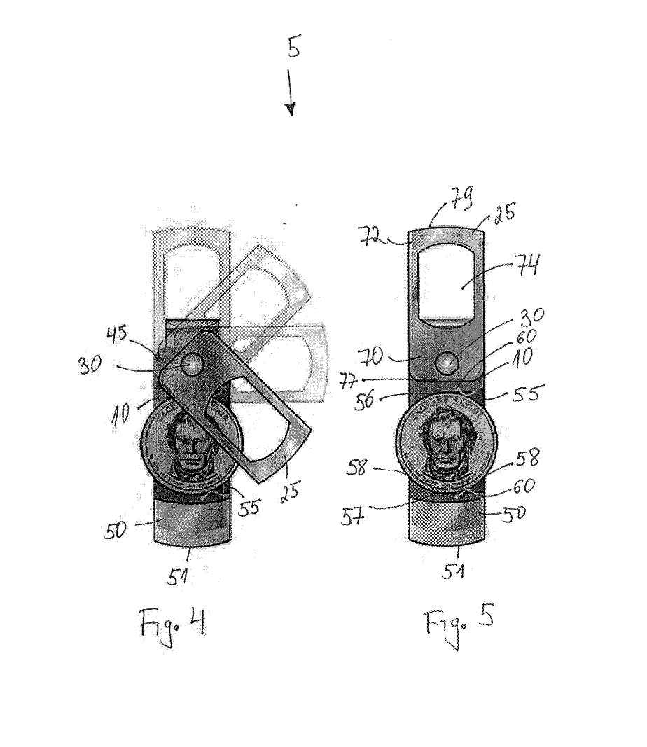

In order to insert or remove coins or paper currency from the money clip 5, a user operates the money clip 5 as follows. When the money clip 5 is in the retracted state and a user wishes to open the money clip 5 to add or remove currency or other items between the legs 65A, 65B of the spring 20, the user pushes the levers 25 to rotate them into their deployed positions as described above. An example of such deployed positions (where the levers 25 are each rotated 180 degrees) is shown in FIGS. 3 and 5. At that time, a user pinches the second ends 72 of the levers 25 (see FIG. 8) to open the legs 65A, 65B and the arms 10 of the money clip 5 against the spring force that holds the legs 65A, 65B and arms 10 together. After the user opens the legs 65A, 65B and arms 10, the user can insert or remove paper currency and/or other items within money clip 5. With continued reference to the illustrated embodiment, if the user only wishes to remove and/or insert one or more coins in one or more recesses 55 as described above, the user can either move the levers 25 to their deployed positions and to insert the face of each coin into the recess 55, or can leave the levers 25 in their retracted positions and insert the coin(s) edge-wise between the levers 25 and the arms 10 into the recesses 55.

It will be appreciated that the dual function of the levers 25 described above and illustrated in the accompanying figures (i.e., providing stowable and deployable features for opening and closing arms 10 of the money clip 5, and well as providing elements that selectively cover and retain coins in recesses of the money clip 5) need not be provided in other embodiments of the present invention. In particular, in some embodiments the levers 25 need not perform the function of enabling a user to open the arms 10 of the money clip 5, but can still perform the function of providing elements that selectively cover and retain coins in recesses of the money clip 5. Likewise, in some embodiments the levers 25 still perform the function of enabling a user to open the arms 10 of the money clip 5, but do not also perform the function of providing elements that selectively cover and retain coins in recesses of the money clip 5. Also, it will be appreciated that other embodiments of the present invention need not necessarily utilize rotating levers 25 at all, opting instead for elements having a similar or different size and shape that each at least partially cover recesses 55 as described above in order to retain coins therein. In such embodiments, a user simply inserts or removes coins into the recesses 55 in an edge-wise manner as described above, which coins can in some embodiments be retained in the recesses 55 at least in part by the springs 60 (or alternatives thereto) described above. It should be noted that in these and other embodiments described and illustrated herein, the recesses 55 need not necessarily be defined in the exterior surfaces of the arms 10. Rather, either or both recesses 55 can instead be defined in interior surfaces of the arms 10 (whereby coins can thereby be retained between the arms 10 and the legs 65A, 65B of the spring 20) or between interior and exterior portions of the arms 10 (i.e., between layers of each arms 10).

Thus, the invention provides, among other things, a money clip 5 with levers 25 that are rotatable between retracted and deployed positions to enable opening of the money clip 5 and/or to provide selective access to coins held within recesses of the money clip 5. Various features and advantages of the invention are set forth in the following claims.

What is claimed is:

1. A money clip comprising:
a spring;
a pair of arms joined by the spring, each arm including at least one recess configured to hold coin currency;
a pair of levers each configured to rotate from a retracted position to a deployed position;
wherein the levers support the coin currency when in retracted position and can be pinched together to open the money clip when in deployed position.

2. The money clip of claim 1, further comprising a pair of pins coupling the pair of levers to the respect arm of the pair of arms.

3. The money clip of claim 2, wherein the pair of pins each define an axis extending in the elongate direction, and wherein each lever is rotatable about the respective axis.

4. The money clip of claim 1, wherein the at least one recess in each arm is substantially centrally located in the respective arm.

5. The money clip of claim 1, wherein the at least one recess includes at least one curved shoulder sized to matingly engage an edge of the coin currency.

6. The money clip of claim 1, further comprising at least one spring positioned in the at least one recess, wherein the at least one spring is configured to retain the coin currency in the respective recess.

7. The money clip of claim 1, wherein the at least one recess is sized to receive more than one coin currency.

8. The money clip of claim 1, wherein the spring includes a pair of legs joined by a curved end, such that the spring has a U-shaped cross section.

9. The money clip of claim 1, wherein the pair of levers each includes an opening positioned adjacent to the recess when the pair of levers are in the retracted position.

10. The money clip of claim 1, wherein the pair of levers covers the coin currency in the retracted position and exposes the coin currency in the deployed position.

11. A method of retaining money in a money clip, the method comprising:
positioning money between legs of a spring;
joining a pair of arms to the spring, each arm including at least one recess configured to hold coin currency;
coupling a pair of levers to the respective one of the pair of arms;
rotating each lever from a retracted position to a deployed position;
supporting the coin currency when the levers are in the retracted position; and
opening the money clip by pinching the legs of the spring together when the levers are in the deployed position.

12. The method of claim 11, wherein coupling the pair of levers to the respective one of the pair of arms including inserting a pair of pins through the respective one of the pair levers and the pair of arms.

13. The method of claim 12, wherein rotating each lever includes rotating each lever about the respective pin.

14. The method of claim 11, further comprising providing a recess in each of the pair of arms, such that the recesses are sized to receive coin currency.

15. The method of claim 14, further comprising providing the at least one recess with at least one curved shoulder sized to matingly engage an edge of the coin currency.

16. The method of claim 14, further comprising retaining the coin currency with at least one spring positioned in the at least one recess.

17. The method of claim 14, further comprising sliding the coin currency into the at least one recess between the arm and the lever without moving the lever to the deployed position.

18. The method of claim 14, further comprising moving the lever to the deployed position and inserting the coin currency into the at least one recess.

19. The method of claim 11, positioning an opening in each of the pair of levers each adjacent to the respective recess when the pair of levers are in the retracted position.

20. The method of claim 11, further comprising covering the coin currency when the pair of levers are in the retracted position and exposing the coin currency when the levers are in the deployed position.
